(19) United States
(12) Patent Application Publication
(10) Pub. No.: US 2019/0377423 A1
(43) Pub. Date: Dec. 12, 2019

(54) User interface controlled by hand gestures above a desktop or a keyboard

(71) Applicant: Gergely Marton, Budapest (HU)

(72) Inventor: Gergely Marton, Budapest (HU)

(21) Appl. No.: 16/438,372

(22) Filed: Jun. 11, 2019

Related U.S. Application Data
(60) Provisional application No. 62/684,017, filed on Jun. 12, 2018.

(51) Int. Cl. G06F 3/023; G06F 3/01

(52) U.S. Cl. CPC G06F 3/023; G06F 3/017

(57) ABSTRACT

The keyboard, the mouse, the touchpad and the touchscreen are among the most commonly used devices for issuing commands to computers. While the keyboard is a very effective device for generating text and basic input commands, the mouse and the touchpad are more suitable input devices for graphical user interfaces. The mouse and the touchpad are separated from the keyboard in space, and a computer user usually has to move her hands back and forth between these devices and the keyboard. Moreover, the mouse and the touchpad require additional hardware and free space e.g. on a laptop computer or on a desktop next to the keyboard. This invention provides a user interface system for a laptop or tablet computer allowing the user to control her device via hand gestures while keeping her hand or hands above the keyboard area of a laptop or comfortably in front of a tablet.

### CROSS-REFERENCE TO RELATED APPLICATIONS

This application claims the benefit of provisional patent application No. 62/684,017, filed Jun. 12, 2018, which is hereby incorporated by reference herein in its entirety.

### FIELD

The present invention relates, in general, to user interfaces for computerized systems, and in particular to user interfaces based on hand movements and gestures.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The keyboard, the mouse, the touchpad and the touchscreen are among the most commonly used devices for issuing commands to computers. While the keyboard is a very effective device for generating text and basic input commands, the mouse and the touchpad are more suitable input devices for graphical user interfaces. The mouse and the touchpad are separated from the keyboard in space, and a computer user usually has to move her hands back and forth between these devices and the keyboard. Moreover, the mouse and the touchpad require additional hardware and free space e.g. on a laptop computer or on a desktop next to the keyboard. The touchscreen is another commonly employed device which can be relatively conveniently used as an input for a graphical user interface. However, during its use a portion of the screen is blocked from view by the hand of the user. Moreover, e.g. in the case of a tablet computer placed on a desk horizontally, the user has to lean over the touchscreen during its use, while if the device is set up vertically, the user has to keep her hands up in the air for giving commands.

U.S. Pat. No. 5,821,922 titled “Computer having video controlled cursor system” describes a device with which a user can control a cursor with her hands kept above the keyboard of a computer. However, in that solution the user has to remove her hand from an observation zone (i.e. the keyboard) and then move it back in order to activate a cursor control mode, which requires from the user of the system to apply the similar effort as if she used a computer mouse or touchpad.

With the Leap Motion controllers by Leap Motion Inc. (San Francisco, Calif., USA, acquired by UltraHaptics in 2019) a user can control a computer with hand gestures, however, the hand still needs to be kept up in the air during the use of the controller.

Systems and methods in accordance with various embodiments of the present disclosure may overcome the above mentioned disadvantages of conventional user interface systems, enabling improved user experience.

### SUMMARY

In one aspect, an example embodiment presented herein provides a user interface system for a computer based on an existing user interface system which existing user interface system is equipped with a keyboard and a user feedback element such as a screen. This example embodiment allows the user to give instructions for the computer via hand gestures while keeping her hand or hands above the keyboard area.

In another aspect, an example embodiment presented herein provides a user interface system for a computer which computer is equipped with a user feedback element such as a screen. This example embodiment allows the user to give instructions for the computer via hand gestures while keeping her hand or hands above an approximately horizontal interaction surface located between her and the feedback element of the user interface system.

In another aspect, an example embodiment presented herein provides a user interface system which can receive inputs from a user by interpreting her hand gestures and according to the thus received inputs performs one or more of the following functions in accordance with the functions of a computer mouse, touchpad or touchscreen: input system activation, moving a cursor, generating clicking commands, scrolling, zooming, providing the function of a continuously pressed button.

In another aspect, an example embodiment presented herein provides a user interface system which can receive inputs from a user by interpreting her hand gestures and according to the thus received inputs performs preprogrammed tasks such as expressing feelings in relation to a content on a social network, starting an audio player software, adjusting the volume of an audio speaker, etc.

In another aspect an example embodiment presented herein provides a user interface system with which the user can construct a library of user-specific hand gestures and user-specific computer-executable commands corresponding to the user-specific hand gestures. The user interface system can include a machine learning process, suitable for classifying control commands based on extracted features from hand positions and hand configurations as well as the variations of these features in time.

These as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to be illustrative embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF DRAWINGS

FIGS. 1A-1B are illustrating example user interface systems which can be controlled by hand gestures.

FIG. 2 is a block diagram of an example user interface system which can be controlled by hand gestures.

FIG. 3 illustrates an example flowchart of a computer-implemented method which can be used in accordance with various embodiments, and which method can generate signals mimicking basic mouse functions.

FIG. 4 illustrates an example flowchart of a computer-implemented method which can be used in accordance with various embodiments, and which can utilize a library of hand gestures and can execute pre-determined actions corresponding to the hand gestures in the library.

FIGS. 5A-5E illustrate some examples of hand gestures which may correspond, for example, to activate a mode of the user interface system in which mode the user can move a cursor and generate click commands.

FIGS. 6A-6B illustrate example features on a hand, which features can be used individually or in combination for example to control the movement of a cursor on a screen.

FIGS. 7A-7F illustrate example sequences of hand postures which can correspond in the user interface system to be the equivalents of a mouse left click and a mouse right click.

FIGS. 8A-8F illustrate further example sequences of hand postures which can correspond in the user interface system to be the equivalents of a mouse left click and a mouse right click.

FIGS. 9A-9F illustrate further example sequences of hand postures which can correspond in the user interface system to be the equivalents of a mouse left click and a mouse right click.

FIG. 10 illustrates an example hand posture which can correspond in the user interface system to be the equivalent of a mouse left button pressed.

FIGS. 11A-11G illustrate example sequences of hand postures which can correspond in the user interface system to be the equivalents of a scroll command.

FIGS. 12A-12B illustrate example sequences of hand postures which can correspond in the user interface system to be the equivalents of a zoom command.

### DESCRIPTION OF EMBODIMENTS

Systems and methods in accordance with various embodiments of the present disclosure may render a user interface system, in accordance with which user interface system hand gestures can be used in order to provide input to a computer.

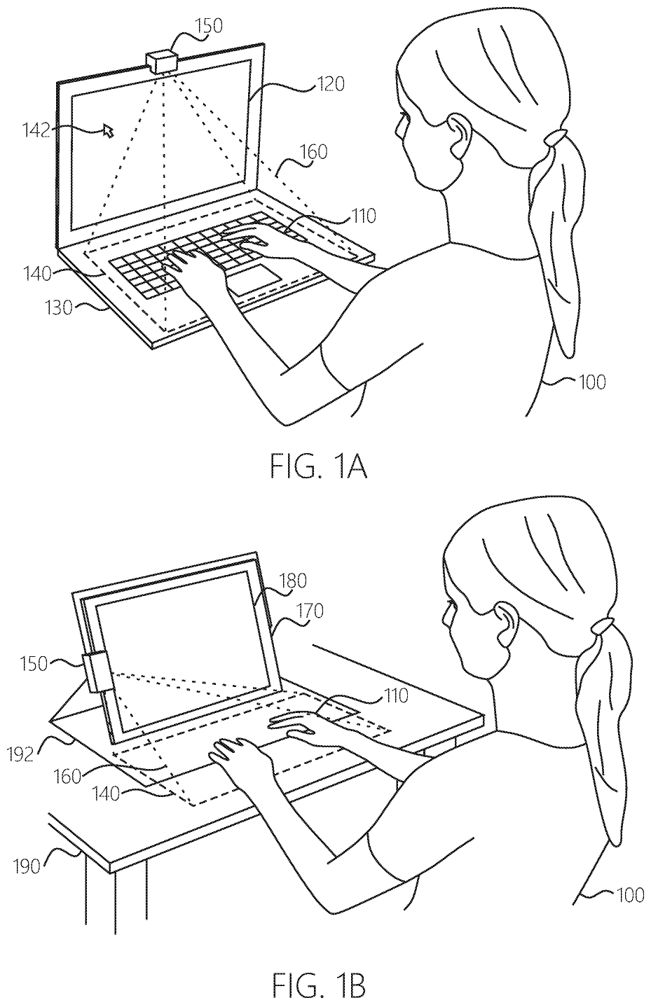

FIG. 1A illustrates an example user interface system for receiving commands from user 100, the commands can be given via gestures of hand 110 of user 100, and the effects of the commands may be fed back to user 100 on screen 120 of the user interface system. The user interface system can be based on a laptop computer 130. Laptop computer 130 contains a keyboard. Screen 120 of the user interface system can correspond to the screen of laptop computer 130. The user interface system contains an interaction surface 140. In this example, interaction surface 140 is the top surface of the housing of laptop computer 130, which housing includes a keyboard and a touchpad. The user interface system can receive commands from hand 110 of user 100 while hand 110 is kept above interaction surface 140. The user interface system can include a cursor 142. The user interface system can further include an image-capture device 150 for retrieving data from the hand 110 (or the other hand or both hands) of user 100 while kept above interaction surface 140. The image-capture device 150 has a field of view 160 which includes, not necessary exclusively, interaction surface 140. The image-capture device 150 can include one or more camera or stereo camera which can be mechanically attached at the top edge of screen 120, and can be connected for data transfer via wired or wireless connection to laptop computer 130. The image-capture device 150 can also be the integrated webcam of laptop computer 130 with specially modified field of view 160, utilizing the method described in pending U.S. patent application Ser. No. 15/859,781. Image-capture device 150 can be equipped with one or more integrated infrared light source for providing additional illumination for interaction surface 140.

FIG. 1B illustrates another variant of the user interface system. In this example, the user interface system is based on tablet computer 170, which includes touchscreen 180. Tablet computer 170 can be held in an approximately vertical position on desk 190 by a foldable tablet case 192 for providing a convenient view for user 100. In this example, the convenient interaction surface 140 for hand 110 of user 100 includes a portion of desk 190 and foldable tablet case 192, i.e. the horizontal surfaces in front of touchscreen 180. In this example, image-capture device 150 is located on the left edge of tablet computer 170. The field of view 160 of image-capture device 150 includes, not necessary exclusively, interaction surface 140.

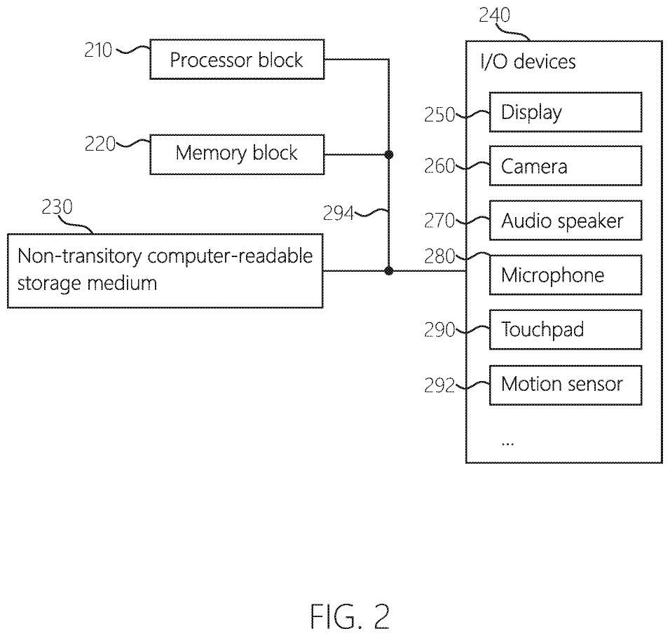

FIG. 2 illustrates a block diagram of an example hardware system in accordance with an example embodiment of the user interface system. The example hardware system contains a processor block 210, memory block 220, a non-transitory computer-readable storage medium 230, user input/output (I/O) devices 240 such as a display 250, a camera 260, an audio speaker 270, a microphone 280, a touchpad 290, a motion sensor 292, etc. In the example embodiment, the processor block 210, the memory block 220 and the I/O devices 240 are interconnected with each other through system bus 294. One or more general multi-purpose processors (e.g. Intel microprocessor) or more specialized processors, such as graphics processing units (GPUs, e.g. NVIDIA GPU), field programmable gate arrays (FPGA, e.g. Xilinx FPGA), or a mixture of these can form the processor block 210. Random access memory (RAM) of desktop personal computers, laptops, tablets, smartphones can serve as memory block 220, and they can be substituted or completed with integrated memory elements corresponding to processor block 210, such as registers and cache memory. The memory block 220 can store instructions for the processor block 210 such as command generation for data transfer, image analysis, signal generation for display 250. The non-transitory computer-readable storage medium 230 can be accessed by at least one element of the processor block. The non-transitory computer-readable storage medium 230 can be utilized for storing program instructions and additional data, furthermore, it can perform instructions for data storage and retrieval for the execution of methods in accordance with various embodiments. The non-transitory computer-readable storage medium 230 can be, for example, a magnetic hard drive, a volatile or non-volatile memory device, an optical disk, or the combination of such devices. Other than these illustrative examples, any sort of hardware can serve as processor block 210, memory block 220 or non-transitory computer-readable storage medium 230 which are suitable for fulfilling their role in the example embodiment. In some embodiments, elements of the processing block 210, memory block 220 and non-transitory computer-readable storage medium 230 can be located in a server physically distant from the front end of the I/O devices 240 and the user.

The I/O devices 240 can include a display 250, a camera 260. Display 250 can correspond entirely or partly to screen 120. Camera 260 can correspond entirely or partly to image-capture device 150. I/O devices 240 can include data processor and memory elements of their own in order to enable them to perform various tasks (e.g. firmware which contain communication protocols). System bus 294 can include wired and/or wireless interfaces for communication.

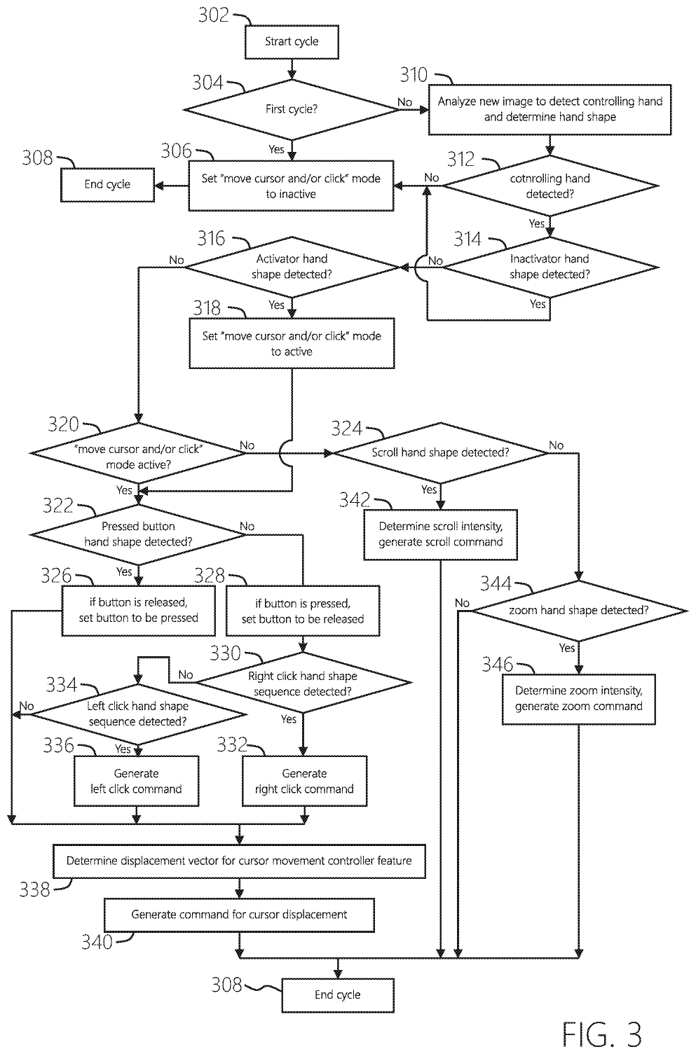

FIG. 3 illustrates an example flowchart of a computer-implemented method which can be used in accordance with various embodiments, and which method can generate signals mimicking basic mouse functions, including movement of a cursor 142, left clicking, right clicking, pressed button function (which can mimic the continuous pressing of the left button of a mouse), scrolling and zooming. The illustrated method can be one cycle of a cyclic process flow, the period of a cycle can be in accordance with the time period which is required for image-capture device 150 to provide new images. In this illustration, for simplicity, single-handed controlling gestures will be assumed with a single controlling hand, and the “hand shape” will refer to the shape of the controlling hand, e.g. the right hand of user 100, but the elements of the method are compatible with multi-handed gestures as well. A “move cursor and/or click” mode can be defined, which mode can be active or inactive. If the “move cursor and click” mode is active, user 100 can move the cursor 142 and/or generate click commands, otherwise not. The illustrated method can start with a “start cycle” step 302, followed by a “first cycle?” decision step 304, which can check whether the process has just started, in which case the “set <move cursor and/or click> mode to inactive” step 306 follows and the method continues with the cycle-ending step 308. Otherwise, if the decision at the “first cycle?” decision step 304 was negative, the method continues with an image analyzer step 310 during which it makes a determination that the latest frame obtained from image-capture device 150 contains at least one hand, and if so, what hand shape or shapes are present in the image. Following the image analyzer step 310, a “controlling hand detected?” decision step 312 is executed, and if no controlling hand is detected the “set <move cursor and/or click> mode to inactive” step 306 follows. If the decision at the “controlling hand detected?” decision step 312 is positive, the method continues with an “inactivator hand shape detected?” decision step 314. If an inactivator hand shape has been detected (which in some embodiments can be the lack of the activator hand shape), the “set <move cursor and/or click> mode to inactive” step 306 follows, otherwise the method continues with an “activator hand shape detected?” decision step 316. If an activator hand shape has been detected, the set “move cursor and click” mode active step 318 follows. If neither activator, nor inactivator hand shapes are detected in steps 314 and 316, respectively, the “move cursor and click” mode remains the same as it was in the previous cycle. In this case, the method follows with a “<move cursor and/or click> mode is active?” decision step 320, and if the mode in question is active, the method continues with a “Pressed button hand shape detected?” decision step 322, otherwise continues with a “scroll hand shape detected?” decision step 324. The “Pressed button hand shape detected?” decision step 322 is also the continuation after the set “move cursor and click” mode active step 318 is executed. At the “Pressed button hand shape detected?” decision step 322 the method checks whether the detected hand shape corresponds to the right mouse button pressed function, and if so, a button press command generator step 326 follows, otherwise, a button release command generator step 328 follows, i.e. the button which mimics continuous pressing of the mouse left button is released if it was pressed as a result of the previous cycles. The button release command generator step 328 is continued with “Right click hand shape sequence detected?” decision step 330 in which the computer decides whether the currently and recently detected hand shapes form a sequence of a right mouse button click, and if so, a right click command generator in step 332 follows, otherwise, the method continues with “Left click hand shape sequence detected?” decision step 334, in which the computer decides whether the currently and recently detected hand shapes form a sequence of a left mouse button click, and if so, the method continues with a left click command is generator step 336. After button press command generator step 326, or if the decision at “Left click hand shape sequence detected?” decision step 334 was negative, or after right click command generator step 332, or after left click command is generator step 336, a displacement vector determining step 338 follows, during which the method determines a displacement vector for a tracked feature (e.g. the tip of the middle finger on the controlling hand) which is utilized to control cursor 142 movements. Following this, the method continues with cursor displacement command generator step 340, in which a command for cursor displacement is generated, after which the previously introduced cycle-ending step 308 ends the cycle. In “scroll hand shape detected?” decision step 324 the method checks whether the detected hand shape corresponds to the scroll function, and if so, the method continues with scroll command generator step 342, in which the computer generates a scroll intensity value based on the currently and recently detected hand shapes and based the thus obtained scroll intensity value generates scroll command. If the decision in “scroll hand shape detected?” decision step 324 was negative, the method continues with “zoom hand shape detected?” decision step 344 in which the method checks whether the detected hand shape corresponds to the zoom function, and if so, the method continues with zoom command generator step 346, in which the computer generates a zoom intensity value based on the currently and recently detected hand shapes and based the thus obtained zoom intensity value generates zoom command. A negative decision in “zoom hand shape detected?” decision step 344 and the of scroll command generator step 342 are both followed by the previously introduced cycle-ending step 308, which ends the cycle.

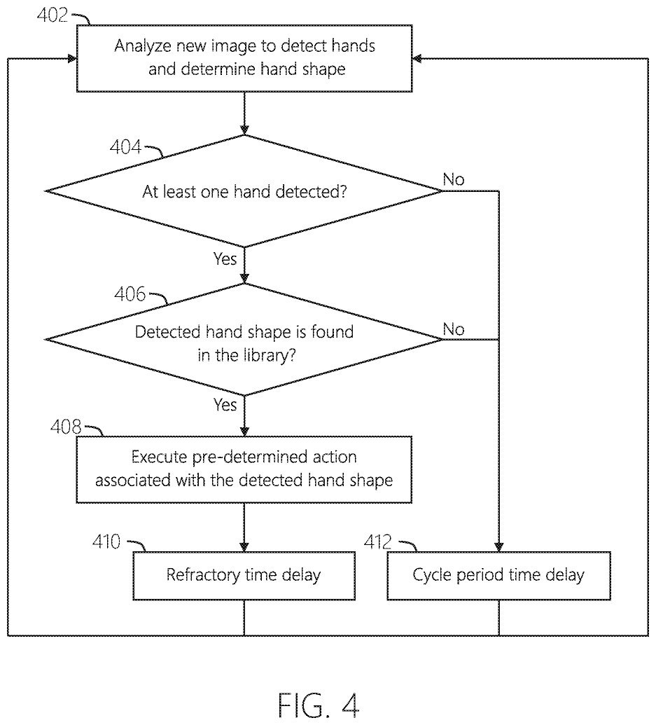

FIG. 4 illustrates an example flowchart of a computer-implemented method which can be used in accordance with one embodiment, and which method can utilize a library of hand gestures and can execute pre-determined actions corresponding to the hand gestures in the library. The method can be a cyclic program, which has an image analyzer step 402 in each cycle. In this step a process is executed that uses the latest frame or some previous frames obtained from image-capture device 150 in order to detect hands and hand shapes in the latest frame. The method continues with an “At least one hand detected?” decision step 404, and if at least hand has been detected in the latest frame, a “Detected hand shape is found in the library?” decision step 406 is executed. If a detected hand shape is found in the hand shape library, the method continues with an action execution step 408, during which the predetermined action is executed which correspond so the detected hand shape. If multiple, conflicting hand shapes are found to which predetermined actions correspond, the method can decide which action to execute based on priority values corresponding to different hand shapes which can also be stored in the hand shape library. After execution step 408, the method can continue with a refractory time delay step 410. This is advantageous in case the execution of an action is time consuming and interference with the method during the execution is unwanted, or if multiple execution of the same or different actions in fast succession is unwanted. After the refractory period, the method can close the cycle by returning to image analyzer step 402. If the decision in either “At least one hand detected?” decision step 404 or “Detected hand shape is found in the library?” decision step 406 is negative, the method can continue with a cycle period time delay step 412. The delay in this step can be chosen so that the new cycle can start when a new frame can be obtained from image-capture device 150. After cycle period time delay step 412, the method can close the cycle by returning to image analyzer step 402.

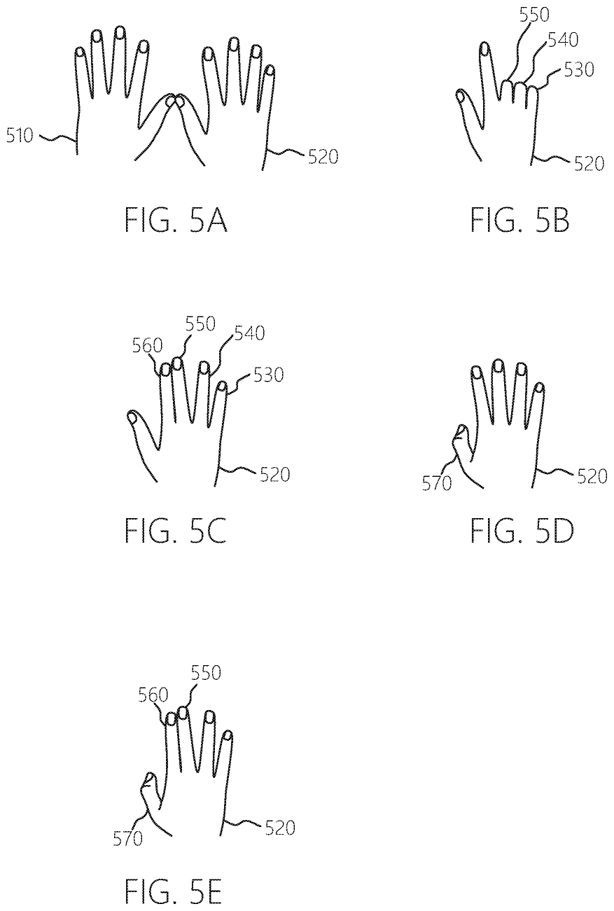

FIGS. 5A-5E illustrate some examples of hand gestures which may correspond, for example, to activate a “move cursor and/or click” mode. It is very important that if a keyboard is present, an activation system should not be triggered by natural typing or a casually relaxed hand shape. FIG. 5A shows an example when user 100 can activate a “move cursor and/or click” mode by touching left hand 510 and right hand 520 together. FIG. 5B shows an example when the user can activate a “move cursor and/or click” mode by simultaneously flexing the pinky finger 530, the ring finger 540, and the middle finger 550 on right hand 520. FIG. 5C shows an example when the user can activate a “move cursor and/or click” mode by extending all fingers and touching the middle finger 550 and index finger 560 together on one hand. FIG. 5D shows an example when the user can activate a “move cursor and/or click” mode by flexing a thumb 570 and extending all other fingers on a right hand 520. FIG. 5E shows an example when the user can activate a “move cursor and/or click” mode by simultaneously flexing a thumb 570 and extending all other fingers and touching together the middle finger 550 and index finger 560 on right hand 520.

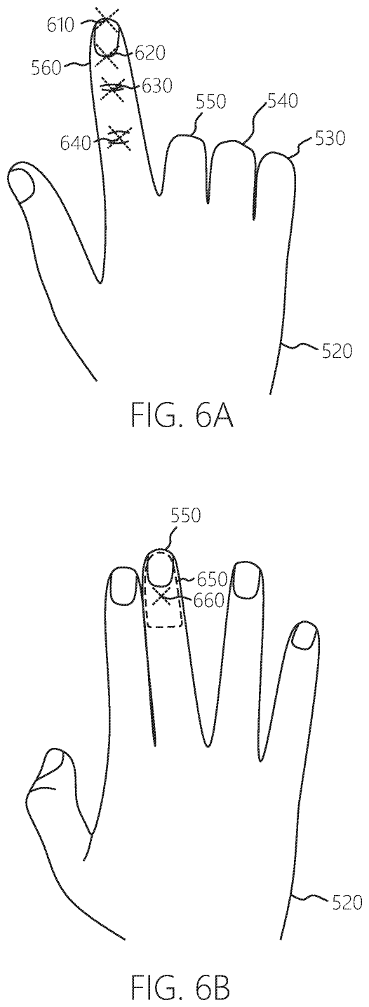

FIG. 6A illustrate four example features on right hand 520 with an extended index finger 560 and flexed middle 550, ring 540 and pinky 530 fingers, which features can be used individually or in combination for example to control the movement of cursor 142 on screen 120. The tip 610 of the index finger 560, the most proximal point 620 of the cuticle at the nail of the index finger 560, the characteristic skin features at the distal interphalangeal joint 630 and at the proximal interphalangeal joint 640 of the index finger 560 can be used as such features. FIG. 6B illustrates an example in which a predefined portion of the middle finger is used for example to control the movement of cursor 142 on screen 120. An image processing algorithm can identify a distal territory 650 on the middle finger 550. The algorithm can calculate the center of gravity 660 of this distal territory and use this point as a basis for providing control signals to control the movement of cursor 142 on screen 120.

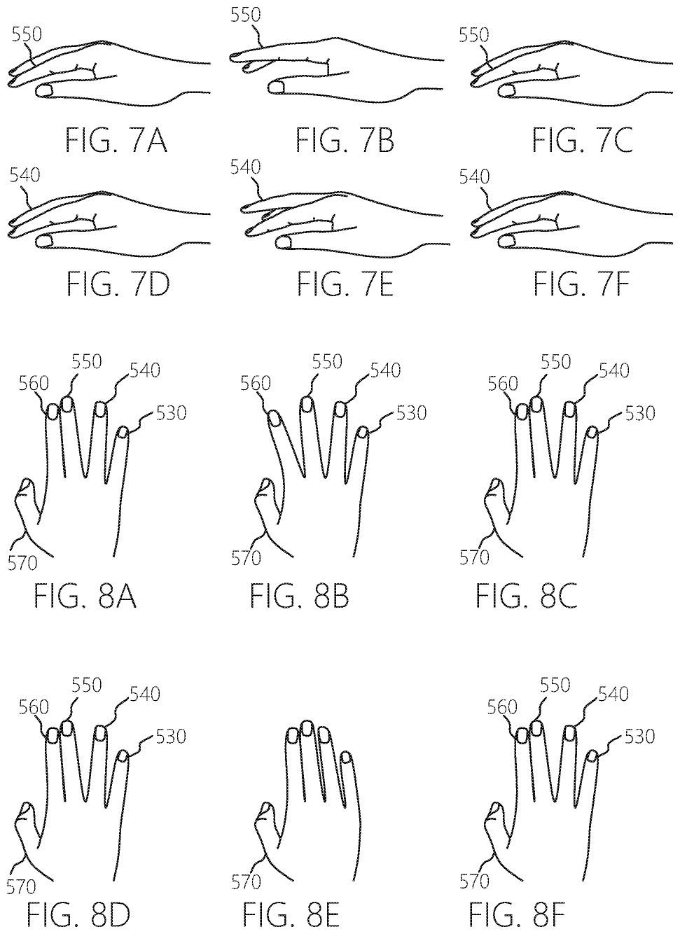

FIGS. 7A, 7B and 7C illustrate an example sequence of hand postures which can correspond in the user interface system to be the equivalent of a mouse left click or a tap on a touchscreen. The sequence shows that user 100 performs a vertical tap with her index finger 550 with comfortably extended fingers. FIGS. 7D, 7E and 7F illustrate an example sequence of hand postures which can correspond in the user interface system to be the equivalent of a mouse right click. The sequence shows that user 100 performs a vertical tap with her middle finger 540 with comfortably extended fingers.

FIGS. 8A, 8B and 8C illustrate another example sequence of hand postures which can correspond in the user interface system to be the equivalent of a mouse left click or a tap on a touchscreen. The sequence shows that at the beginning of the sequence, user 100 flexes her thumb 570 and extends her other four fingers, while the middle 550 and index fingers 560 touch each other and the ring 540 and pinky 530 fingers are separated. FIG. 8B shows that during the sequence she performs a lateral movement with her index finger 560, i.e. separates it from the middle finger 550. The sequence ends with returning to the starting phase, i.e. the index finger 560 is moved back to get in contact with the middle finger 550.

FIGS. 8D, 8E and 8F illustrate another example sequence of hand postures which can correspond in the user interface system to be the equivalent of a mouse right click. The sequence shows that at the beginning of the sequence, user 100 flexes her thumb and extends her other four fingers on a hand, while the middle 550 and index 560 fingers touch each other and the ring 540 and pinky 530 fingers are separated. FIG. 8B shows that during the sequence she performs a lateral movement with her pinky 530 and ring 540 fingers, i.e. moves them towards the middle finger 550. The sequence ends with returning to the starting phase, i.e. the ring 540 and pinky 530 fingers are moved back to be separated from the middle finger 550.

The example sequences of FIGS. 7A, 7B, 7C; FIGS. 7D, 7E, 7F, FIGS. 8A, 8B, 8C and FIGS. 8D, 8E and 8F are compatible for example with the example activation hand gesture illustrated in FIG. 5E and the example method for cursor control illustrated in FIG. 6B.

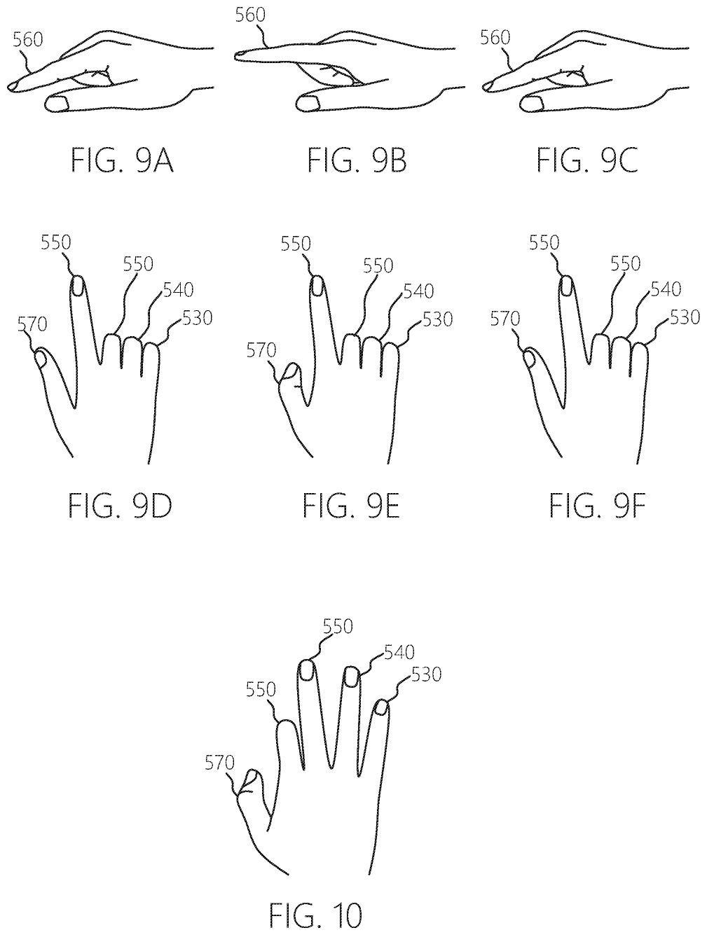

FIGS. 9A, 9B and 9C illustrate another example sequence of hand postures which can correspond in the user interface system to be the equivalent of a mouse left click or a tap on a touchscreen. The sequence shows that user 100 performs a vertical tap with her extended index finger 560 with flexed middle 550, ring 540 and pinky 530 fingers. FIGS. 9D, 9E and 9F illustrate another example sequence of hand postures which can correspond in the user interface system to be the equivalent of a mouse right click. The sequence shows that user 100 flexes her thumb 520 and then extends her thumb 520 back with extended index finger 560 and flexed middle 550, ring 540 and pinky 530 fingers.

The example sequences of FIGS. 9A, 9B, 9C and FIGS. 9D, 9E, 9F are compatible for example with the example activation hand gesture illustrated in FIG. 5B and the example methods for cursor control illustrated in FIG. 6A.

FIG. 10 shows an example hand gesture, which may correspond in the user interface system, for example to the equivalent of a continuously pressed left mouse button.

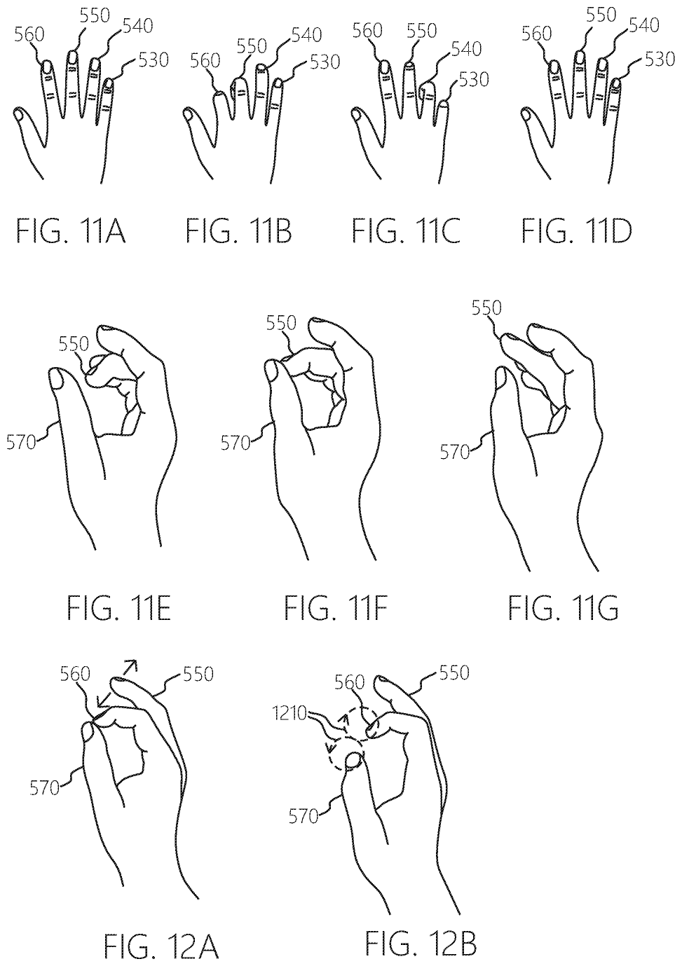

FIGS. 11A, 11B, 11C and 11D illustrate an example sequence of hand postures which can correspond in the user interface system to be the equivalent of a scroll command. The sequence can start with extended fingers, followed by a wave of finger-flexing and re-extending, the wave starting from the index finger 560, affecting the middle 550 and ring 540 fingers and ending with the pinky finger 530. The illustrated sequence can serve, for example, to be the equivalent of a downwards scroll command, while its opposite, i.e. a finger flexing and re-extending wave starting from the pinky finger 530 and ending with the index finger 560, can serve, for example, to be an upwards scroll command.

FIGS. 11F, 11G, and 11H illustrate another example sequence of hand postures which can correspond in the user interface system to be the equivalent of a scroll command. In some embodiments, the sequence can start with rotation of a wrist in order to ensure that image-capture device 150 of the user interface can capture images on which critical parts of the hand are not blocked. During the sequence, user 100 touches her middle finger 550 and thumb 570 together, and simultaneously moves the fingertip of her middle finger 550 away or towards her wrist, and as a result of this, the user interface can respond by generating a downwards or an upwards scroll command, respectively.

FIG. 12A illustrates an example hand starting posture and finger movement which can correspond in the user interface system to be the equivalent of a zoom command. In some embodiments, the starting posture can be achieved by rotation of a wrist in order to ensure that image-capture device 150 of the user interface can capture images on which critical parts of the hand are not blocked. For the starting posture, user 100 touches her index finger 560 and thumb 570 together. When she moves her middle finger 550 closer to or away from her thumb 570, the user interface can respond by generating an inwards or an outwards zoom command, respectively.

FIG. 12B illustrates another example hand starting posture and finger movement which can correspond in the user interface system to be the equivalent of a zoom command. In some embodiments, the starting posture can be achieved by rotation of a wrist in order to ensure that image-capture device 150 of the user interface can capture images on which critical parts of the hand are not blocked.

User can move her thumb tip and index finger tip in two circles 1210, which touch each other at one point. When she moves the tip of her index finger clockwise and her thumb counterclockwise, the user interface can respond by generating an outwards zoom command, while the directions opposed to these can be used for signaling an inwards zoom command.

An example embodiment presented herein provides a user interface system which interprets various hand gestures which are stored in a library and utilizes a lookup table in which lookup table various commands corresponding to such hand gestures are stored. For example, an element of a library can be a first with an extended thumb, i.e. a commonly used “like” hand gesture, and a corresponding command in the lookup table for this gesture can be the expression of a “like” in relation to a content on a social network. Similarly, the “sign of the horns” hand gesture in the library can have a corresponding command in the lookup table of starting an audio player software. An example embodiment presented herein provides a user interface system with which the user can construct a library of user-specific hand gestures, and the lookup table with corresponding computer-executable commands. The user interface system can include a machine learning process, which can be adjusted by repetitive presentation of a hand shape or a sequence of hand shapes to contain user-defined hand shapes or sequence of hand shapes in its library of hand shapes. The machine learning process can be suitable for classifying user inputs based on extracted features from user-defined hand configurations as well as the variations of these features in time, and execute user-specified commands corresponding to these inputs.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

### CITATION LIST

EP 2364470 B1 (Jeffrey P. Bezos), Date of filing: Nov. 20, 2009
U.S. Pat. No. 7,705,830 B2 (Wayne Carl Westerman et al.), Date of filing: Feb. 10, 2006
U.S. Pat. No. 8,959,013 B2 (Micha Galor et al.) Date of filing: Sep. 25, 2011
U.S. Pat. No. 9,330,307 B2 (Shai Litvak et al.) Date of filing: Mar. 3, 2015
US 2016/009 1980 A1 (Andrzej Baranski et al.) Date of filing: Feb. 6, 2015
U.S. Pat. No. 5,821,922 (Charles A. Sellers) Date of filing: May 27, 1997
U.S. Pat. No. 8,558,759 (Luis Ricardo Prada Gomez et al.) Date of filing: Jul. 8, 2011
U.S. Pat. No. 8,179,604 B1 (Luis Ricardo Prada Gomez et al.) Date of filing: Sep. 30, 2011
US 2014/034.0311 A1 (David Holz) Date of filing: May 19, 2014
US 2014/0201689 A1 (Raffi Bedikian et al.) Date of filing: Jan. 14, 2014
US 2014/0320408 A1 (Michael Zagorsek) Date of filing: Apr. 25, 2014
US 2015/0029092 A1 (David Holz et al.) Date of filing: Jul. 23, 2014
U.S. Pat. No. 9,785,247 B1 (Kevin A. Horowitz) Date of filing: May 14, 2015
US 2014/0043230 A1 (Micha Galor et al.) Date of filing: Oct. 17, 2013

1. A controller system for a computer, wherein the computer comprises a display element and an operation system, the controller system comprising:
interaction surface located in front of the display element;
one or more video cameras wherein the one or more video cameras have fields of view in which fields of view the interaction surface is included;
gesture-recognition system with the capability of interpreting one or more gestures generated by one or more users, wherein the gesture-recognition system comprises logic which determines gestures from video data provided by the one or more video cameras and which logic determines one or more gestures based on at least one of the position, movement, orientation and shape properties of one or more predetermined objects within the video data;
capability of initiating one or more predetermined events when one or more gestures are determined by the gesture-recognition system, wherein the one or more predetermined events is one or more of the following: changing mode of operation of the controller system, control of a cursor, scrolling, zooming view, panning view, pressing a virtual button, character input, virtual icon input, clicking, double-clicking, launching a computer application, providing input for a computer application, changing one or more settings of the operation system of the computer, changing one or more settings of a computer application, switching between applications, expressing emotion on a social media platform.

2. The controller system of claim 1, wherein the interaction surface contains at least a part of a keyboard of the computer.

3. The controller system of claim 1, wherein the computer is a tablet computer, and provided the tablet computer is placed on a desktop, the interaction surface at least partly includes the desktop.

4. The controller system of claim 1, wherein the at least one predetermined objects comprises at least one hand of a user of the computer.

5. The controller system of claim 1, wherein the controller system initiates an event of changing mode of operation of the controller system in response to touching one or more predetermined hand parts together by a user of the computer.

6. The controller system of claim 1, wherein the controller system initiates an event of changing mode of operation of the controller system in response to flexing one or more predetermined fingers in one or more predetermined directions by a user of the computer.

7. The controller system of claim 1, wherein the controller system initiates an event of clicking or double-clicking in response to a predetermined movement or series of predetermined movements of one or more predetermined fingers of a hand of a user of the computer, wherein the predetermined movement or series of predetermined movements are evaluated relative to one or more predetermined parts of the said hand of the said user of the computer.

8. The controller system of claim 1, wherein the controller system initiates an event of scrolling in response to a predetermined movement or series of predetermined movements of one or more predetermined fingers of a hand of a user of the computer, wherein the predetermined movement or series of predetermined movements are evaluated relative to one or more predetermined parts of the said hand of the said user of the computer.

9. The controller system of claim 1, wherein the controller system initiates an event of zooming view in response to a predetermined movement or series of predetermined movements of one or more predetermined fingers of a hand of a user of the computer, wherein the predetermined movement or series of predetermined movements are evaluated relative to one or more predetermined parts of the said hand of the said user of the computer.

10. The controller system of claim 1, wherein:
the controller system initiates an event equivalent of a left mouse click in response to a predetermined movement or series of predetermined movements of an index finger of a hand of a user of the computer, wherein the predetermined movement or series of predetermined movements of the index finger are evaluated relative to one or more predetermined parts of the said hand;
the controller system initiates an event equivalent of a right mouse click in response to a predetermined movement or series of predetermined movements of a pinky finger of a hand of a user of the computer, wherein the predetermined movement or series of predetermined movements of the pinky finger are evaluated relative to one or more predetermined parts of the said hand;
the controller system initiates a scrolling event in response to a predetermined movement or series of predetermined movements of a predetermined fingertip of a hand of a user of the computer, wherein the predetermined movement or series of predetermined movements of the predetermined fingertip are evaluated relative to a thumb of the said hand.

11. A method for controlling a computer comprising:
interaction surface located in front of a display element of the computer;
utilization of video data from one or more video cameras wherein the one or more video cameras have fields of view in which fields of view an interaction surface is included;
interpreting one or more gestures generated by one or more users with a gesture-recognition system, wherein the gesture-recognition system comprises logic which determines gestures from the video data provided by the one or more video cameras and which logic determines one or more gestures based on at least one of the position, movement, orientation and shape properties of one or more predetermined objects within the video data;
initiation of one or more predetermined events when one or more gestures are determined by the gesture-recognition system, wherein the one or more predetermined events is one or more of the following: changing mode of operation within the method for controlling the computer, control of a cursor, scrolling, zooming view, panning view, pressing a virtual button, character input, virtual icon input, clicking, double-clicking, launching a computer application, providing input for a computer application, changing one or more settings of the operation system of the computer, changing one or more settings of a computer application, switching between applications, expressing emotion on a social media platform.

12. The method of claim 11, wherein the interaction surface contains at least a part of a keyboard of the computer.

13. The method of claim 11, wherein the computer is a tablet computer, and provided the tablet computer is placed on a desktop, the interaction surface at least partly includes the desktop.

14. The method of claim 11, wherein the at least one predetermined objects comprises at least one hand of a user of the computer.

15. The method of claim 11, wherein an event of changing mode of operation within the method for controlling the computer is initiated in response to touching one or more predetermined hand parts together by a user of the computer.

16. The method of claim 11, wherein an event of changing mode of operation within the method for controlling the computer is initiated in response to flexing one or more predetermined fingers in one or more predetermined directions by a user of the computer.

17. The method of claim 11, wherein an event of clicking or double-clicking is initiated in response to a predetermined movement or series of predetermined movements of one or more predetermined fingers of a hand of a user of the computer, wherein the predetermined movement or series of predetermined movements are evaluated relative to one or more predetermined parts of the said hand of the said user of the computer.

18. The method of claim 11, wherein an event of scrolling is initiated in response to a predetermined movement or series of predetermined movements of one or more predetermined fingers of a hand of a user of the computer, wherein the predetermined movement or series of predetermined movements are evaluated relative to one or more predetermined parts of the said hand of the said user of the computer.

19. The method of claim 11, wherein an event of zooming view is initiated in response to a predetermined movement or series of predetermined movements of one or more predetermined fingers of a hand of a user of the computer, wherein the predetermined movement or series of predetermined movements are evaluated relative to one or more predetermined parts of the said hand of the said user of the computer.

20. The method of claim 11, wherein:
an event equivalent of a left mouse click is initiated in response to a predetermined movement or series of predetermined movements of an index finger of a hand of a user of the computer, wherein the predetermined movement or series of predetermined movements of the index finger are evaluated relative to one or more predetermined parts of the said hand;
an event equivalent of a right mouse click is initiated in response to a predetermined movement or series of predetermined movements of a pinky finger of a hand of a user of the computer, wherein the predetermined movement or series of predetermined movements of the pinky finger are evaluated relative to one or more predetermined parts of the said hand;
a scrolling event is initiated in response to a predetermined movement or series of predetermined movements of a predetermined fingertip of a hand of a user of the computer, wherein the predetermined movement or series of predetermined movements of the predetermined fingertip are evaluated relative to a thumb of the said hand.
